(19) United States
(12) Patent Application Publication
(10) Pub. No.: US 2008/0294887 A1
(43) Pub. Date: Nov. 27, 2008

(54) ACTIVATION METHOD FOR MULTIPLE OPERATION SYSTEMS OF A COMPUTER

(75) Inventor: Chun-Chi WANG, Tucheng City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: MITAC TECHNOLOGY CORP., Hsinchu (TW)

(21) Appl. No.: 11/970,063

(22) Filed: Jan. 7, 2008

(30) Foreign Application Priority Data
May 23, 2007 (TW) 096118373

(51) Int. Cl. G06F 15/177

(52) U.S. Cl. 713/2

(57) ABSTRACT

An activation method for multiple operation systems of a computer, comprising selectively pressing a function key in a keyboard while pressing a power supply key, receiving a signal of the pressed power supply key and a key code of the pressed function key by an embedded controller, determining the operation system desired to be activated according to the received key code by the embedded controller, and informing a basic input/output system by the embedded controller to activate the specific operation system. Therefore, the waiting time spent on selecting operation system in the prior art is eliminated.

### CROSS-REFERENCE TO RELATED APPLICATIONS

This non-provisional application claims priority under 35 U.S.C. §119(a) on Patent Application No(s). 096118373 filed in Taiwan, R.O.C. on May 23, 2007, the entire contents of which are hereby incorporated by reference.

### BACKGROUND

1. Field of Invention

The invention relates to an activation method for a computer operation system, and in particular to an activation method for multiple operation systems of a computer.

2. Related Art

Presently, when starting most of the computers having multiple operation systems, a menu is prompted and displays on a screen for a few seconds, so that a user can make a selection among the various operation systems, to enable the computer loading the operation system desired to be used. In the above-mentioned manner of operation, the user makes the selection only after the computer is powered on. As such, each time the computer is powered on, the user must first perform the selection of operation system to allow the computer to activate the operation system desired to proceed with the operations required. However, in selecting an operation system, the user must wait for an additional latency period.

The user can designate a predetermined operation system in advance, and if the user has not made the necessary selection required, the computer will automatically execute the predetermined operation system. However, in determining by the computer whether the user has made a proper selection, a period of determination is required. Therefore, the problem of how to improve the operation efficiency and convenience of a computer having multiple operation systems is probably a most urgent task in this field.

There exists a multi-key guidance system and method of multiple operation systems. The multi-key guidance system includes: a power-on press-key logic unit, an Embedded Controller (EC) chip and its Random Access Memory (RAM), an inquiry module, and a load-in module. The multi-key guidance method includes the following steps: Firstly, providing a plurality of power-on press keys connected to an EC chip, and specifying a plurality of Master Boot Records (MBR). Next, detecting the corresponding variations of the EC chip signals incurred by a specific press key pressed down, and writing the corresponding identification information into the RAM of an EC chip. Then, searching and finding out the pre-defined and corresponding MBR according to the identification information, and loading in the corresponding MBR. And finally, guiding and directing the corresponding operation system based on the loaded-in MBR.

However, in the above-mentioned computer activation, an additional power-on press key circuit has to be designed and provided, and therefore, the production cost of computer is increased. Thus, this kind of technology still has much room for improvement.

### SUMMARY

In view of the above-mentioned drawbacks and shortcomings of the prior art, the objective of the invention is to provide an activation method for multiple operation systems of a computer. In activating a computer, whether the preset press key in a keyboard is pressed is verified immediately through an embedded controller (EC).The operation system desired to be loaded is determined according to the pressed preset press key. Therefore, the operation efficiency and convenience of a computer having multiple operation systems are improved.

To achieve the above-mentioned objective, the invention discloses an activation method for multiple operation systems of a computer. The computer has operation systems, a power supply key and a keyboard with function keys. The activation method is used for loading the operation system desired to be activated according to the pressed function key. Firstly, when pressing the power supply key, selectively pressing one of the function keys at the same time. Next, a signal of the pressed power supply key and a key code of the pressed function key are received by an Embedded Controller. Then, the operation system desired to be activated is determined by the embedded controller according to the key code of the pressed function key. Finally, a basic input/output system (BIOS) is informed by the embedded controller to activate the operation system.

The activation method for multiple operation systems of a computer according to the invention utilizes a way to use the keys in combination, i.e. the power supply key and the function keys are utilized in combination. Therefore, in powering on a computer system, the selection procedure of multiple operation systems is executed according the pressed keys, and then is completed at the same time, to eliminate the waiting time spent on selecting operation system; and further, to improve the operation efficiency and convenience of a computer having multiple operation systems.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given herein below for illustration only, and thus are not limitative of the present invention, and wherein:

FIG. 1 is a flowchart of an activation method for a computer having multiple operation systems according to an embodiment of the invention.

### DETAILED DESCRIPTION

The purpose, construction, features, and functions of the invention can be appreciated and understood more thoroughly through the following detailed description with reference to the attached drawings.

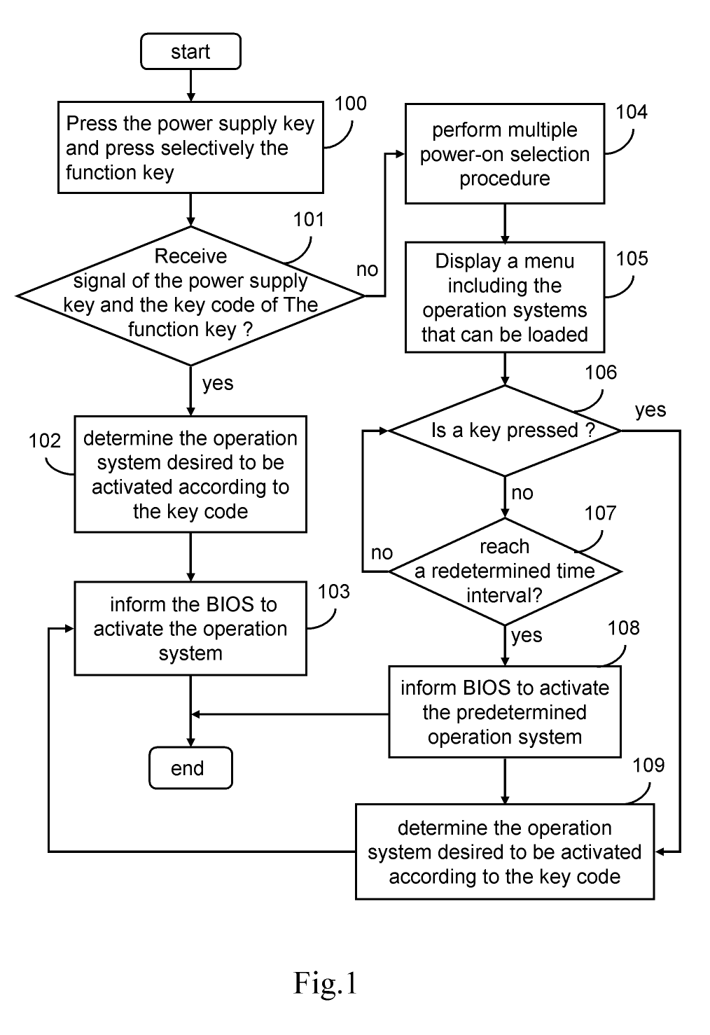

Refer to FIG. 1 shown a flowchart of an activation method for multiple operation system of a computer according to an embodiment of the invention. The computer has more than two operation systems, a power supply key and a keyboard with a plurality of function keys. A corresponding relation between the operation systems (such as, Windows operation system, Linux operation system and/or Mac operation system etc.) to be activated and the function keys (for example, F1, F2, F3, and F4 etc.) in the keyboard is defined and established in the computer in advance. When starting the computer, the operation system desired to be activated is loaded according to the pressed function key. As such, the activation method includes the following steps.

Firstly, while pressing down the power supply key, a user selectively presses one of the function keys in the keyboard at the same time (step 100). Thus, in pressing the power supply key, an embedded controller disposed in a computer and electrically coupled to a keyboard circuit is turned on to perform an activation operation. Moreover, as people familiar with this art will appreciate that, the embedded controller described in the present embodiment can be replaced by a keyboard controller (KBC), a single chip having programmable functions, or a processor, and that is also within the sphere and domain of the invention. In step 100, the user can select to press the power supply key and the function key of the keyboard at the same time, to realize a computer activation procedure and an operation system selection procedure. Alternatively, the user can merely press the power supply key, to realize the computer activation procedure. In addition, in the present embodiment, symbols, characters, or icons can be disposed on the function keys of the keyboard or nearby, to indicate the activated operation system corresponding to the pressed function key.

Next, whether the embedded controller receives a signal of the pressed power supply key and a key code of the pressed function key or not is checked (step 101). For receiving the signal of the function key, the embedded controller, for example, can be electrically coupled to a keyboard circuit via a General Purpose Input Output (GIOP) pin. Then, the contents and meaning of the key code of the function key can be determined through a pressed key decoding operation.

When the embedded controller receives the signals of the power supply key and the key code of the function key, the embedded controller determines the operation system desired to be activated based on the key code of the pressed function key (step 102). In one embodiment, the embedded controller can determine the operation system desired to be activated based on the key code of the pressed function key though use of a pre-defined table of the corresponding relation.

Subsequently, the embedded controller informs a Basic Input Output System (BIOS) to activate the operation system (step 103). In one embodiment, the basic input output system (BIOS) loads the specific operation system into Master Boot Record (MBR) therein based on the command issued by the embedded controller. The MBR is provided with a disk partition table and the power-on execution program codes required. As such, the power-on execution program codes are performed to search the disk partition table to find out the disk partition in use, and delegate the control authority to a Power-On Record on the disk partition is use, and then load the activated operation system into the Power-On Record.

Moreover, when that the embedded controller does not receive any signal, e.g. the key code, of function key after the embedded controller activates, then the computer executes a multiple power-on selection procedure (step 104).

Furthermore, the computer executes a menu program code, to display a menu indicating the operation system that can be loaded on a displaying device, e.g. a screen (step 105).

The embedded controller detects the keyboard, to determine if there are any keys pressed in keyboard (step 106). In one embodiment, the embedded controller can determine if there are any keys pressed through detecting the variation of the signal at a General Purpose Input Output (GIOP) pin coupled electrically to a circuit of the keyboard. Then, it can be determined that the pressed key is an ordinary key or a function key through the pressed key decoding operation.

Moreover, when the embedded controller detects and finds out that no key has been pressed, a timer starts to count the time, and subsequently the embedded controller determines that if it has reached a predetermined time interval (for example, 5 seconds or 10 seconds) as based on the results of timing (step 107).

Subsequently, upon reaching a predetermined time interval in displaying a menu, while the embedded controller checking and verifying that no function key has been pressed, the embedded controller informs the basic input/output system to activate the predetermined operation system (step 108). In one embodiment, the basic input/output system (BIOS) loads the specific operation system into a MBR according to the command issued by the embedded controller. The MBR is provided with the disk partition table and the power-on execution program codes required. The power-on execution program codes are performed to search the disk partition table to find out the disk partition in use, and delegate the control authority to a Power-On Record on the disk partition is use, and then load the activated operation system into the Power-On Record.

When the embedded controller detects that there are function keys pressed, the embedded controller determines the operation system to be activated based on the key code of the pressed function key (step 109). And finally, the process proceeds to the step 103, thereby informing the BIOS to load the specific operation system.

In the following, the operation details of the embodiment of the invention are described. Firstly, a well-defined corresponding table is stored in advance in a computer system. The corresponding table can be stored for example in a non-volatile memory, thus it may be read by the embedded controller when computer is powered on each time. The contents of table 1 are as follows.

TABLE 1

| function key | key code | operation system to be activated |
|---|---|---|
| F1 | F005 | Windows operation system |
| F2 | F006 | Linux operation system |
| F3 | F007 | Mac operation system |
| F4 | F008 | Unix operation system |

When the user desires to activate a Linux operation system, the Linux operation system is activated through pressing the power supply key and the function key “F2” in the keyboard by the user. After the power supply key and the function key “F2” are pressed, the embedded controller is activated, and then determines whether the function key in the keyboard is pressed. Then, since the user presses the function key “F2”, the embedded controller reads and obtains the key code “F006” corresponding to the function key “F2” through the pressed key decoding operation. After searching the table of the corresponding relation (table 1), the embedded controller determines that the operation system to be activated is the Linux operation system, and then informs the basic input/output system to activate the Linux operation system

When the user merely presses the power supply key but does not press any function keys at the same time, the embedded controller detects and can not obtain any key code. Therefore, the multiple power-on selection procedure is performed, and a menu indicating the operation systems that can be activated selectively is displayed on the displaying device, e.g. the screen, and its contents are for example as follows: 1. Windows Operation System; 2. Linux Operation System; 3. Mac Operation System; and 4. Unix Operation System. In this case, a numeric key “4” in the keyboard is pressed by the user, and then the Unix operation system is activated upon completion of the power-on procedure of the computer.

In this embodiment, the predetermined operation system is a Windows operation system. If a designated press key is not pressed by the user in the menu displaying stage and the menu displaying interval reaches for example 5 seconds, the embedded controller informs the basic input/output system to activate the predetermined operation system, i.e. the Windows operation system.

Summing up the above, in an activation method for multiple operation systems of a computer according to the invention, a key combination operation manner is utilized. Thus, in activating the computer system operation, the selection procedure of multiple operation systems is executed and completed, hereby saving the waiting time spent on selecting an operation system, thus raising the operation efficiency and convenience of a computer having multiple operation systems.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An activation method for multiple operation systems of a computer, the computer having a plurality of operation systems, a power supply key and a keyboard with a plurality of function keys, the activation method for loading the operation system desired to be activated according to the pressed function key, comprising:
selectively pressing the function key while pressing the power supply key;
receiving a signal of the pressed power supply key and a key code of the pressed function key by an embedded controller;
determining the operation system desired to be activated by the embedded controller according the received key code; and
informing a basic input/output system by the embedded controller to activate the determined operation system.

2. The activation method for multiple operation systems of a computer as claimed in claim 1, further comprising:
when the embedded controller does not receive the key code of the function key, performing a multiple power-on selection procedure by the computer.

3. The activation method for multiple operation systems of a computer as claimed in claim 2, wherein the step of performing the multiple power-on selection procedure comprises:
executing a menu program code to display a menu indicating the operation systems that can be loaded;
detecting the keyboard by the embedded controller to determine whether a key in the keyboard is pressed;
determining the operation system desired to be activated according the key code of the pressed key in the keyboard by the embedded controller; and
informing the basic input/output system by the embedded controller to activate the determined operation system

4. The activation method for multiple operation systems of a computer as claimed in claim 3, wherein the step of performing the multiple power-on selection procedure further comprises:
when the menu has been displayed for a predetermined time interval, and the embedded controller verifies and finds out that no the key in the keyboard is pressed, informing the basic input/output system to activate the predetermined operation system.

5. The activation method for multiple operation systems of a computer as claimed in claim 1, further comprising:
defining a corresponding relation between the operation systems and the function keys.
